(19) United States
(12) Patent Application Publication
(10) Pub. No.: US 2019/0320700 A1
(43) Pub. Date: Oct. 24, 2019

(54) PRODUCE WASHER

(71) Applicant: Brett Wansitler, Portage, OH (US)

(72) Inventor: Brett Wansitler, Portage, OH (US)

(21) Appl. No.: 16/390,298

(22) Filed: Apr. 22, 2019

Related U.S. Application Data
(60) Provisional application No. 62/660,583, filed on Apr. 20, 2018.

(51) Int. Cl. A23N 12/02; B08B 3/10; B08B 1/00

(52) U.S. Cl. CPC A23N 12/02; B08B 1/002; B08B 3/10

(57) ABSTRACT

A produce washer comprises a housing defining an interior for passing produce therethrough. The interior of the housing is divided into a brushing zone and a spraying zone. A brush assembly is disposed within the brushing zone of the housing and includes a plurality of rotary brushes. A conveyer assembly is disposed within the spraying zone and includes a conveyer belt having through openings formed therein for allowing a liquid to pass through the conveyer belt. A dispensing system of the produce washer dispenses the liquid at the produce within each of the brushing zone and the spraying zone. A recirculation system of the produce washer returns the dispensed liquid back to dispensing system after being filtered by a filtration system of the produce washer formed by at least one hydrosieve.

### CROSS-REFERENCE TO RELATED APPLICATIONS

This patent application claims priority to U.S. Provisional Patent Application Ser. No. 62/660,583, filed on Apr. 20, 2018, the entire disclosure of which is hereby incorporated herein by reference.

### FIELD OF THE INVENTION

The present disclosure relates to a washing apparatus, and more specifically, a washing apparatus for the washing and rinsing of produce such as fruit and vegetables.

### BACKGROUND OF THE INVENTION

Produce, such as fruits and vegetables, need to be washed for food safety purposes. However, a spray providing fine water droplets with a substantial impact force would bruise or damage the produce. Furthermore, the use of a cleansing agent to wash produce may leave an unacceptable aftertaste, or cause an unacceptable chemical reaction with the produce resulting in deterioration or damage to the produce. A high-temperature washing process could also wilt or otherwise damage the produce.

In order to facilitate improved washing of the produce for the desired operating conditions, it may be beneficial to further introduce a cleaning utensil such as a brush for removing dirt or debris from an outer surface of the produce. However, such cleaning utensils present additional challenges that must be addressed. The abrasiveness of the cleaning utensil may scratch, bruise, or otherwise damage the produce during the washing process. Furthermore, such cleaning utensils generally require routine cleaning, maintenance, or replacement in order to maintain the hygienic properties of the cleaning utensil. This occurs because such cleaning utensils are typically formed from a bristled or a porous surface in a manner wherein the dirt or debris removed from the produce can become embedded within the bristled or porous surface of the cleaning utensil. Additionally, such cleaning utensils having bristles or porous surfaces tend to easily absorb and retain liquids such as water therein, thereby presenting a suitable environment for fungus or bacteria to propagate and then be transferred to the produce being washed.

It is therefore desirable to provide a new and improved apparatus and method for washing produce that protects the produce while maximizing the removal of dirt and debris from the produce.

### SUMMARY OF THE INVENTION

Consonant with the present disclosure, an efficient and hygienic produce washer configured for high volume and continuously recirculated liquid flow has surprisingly been discovered.

In one embodiment of the disclosure, a produce washer comprises a housing defining an interior for passing produce therethrough. The interior of the housing is divided into a brushing zone and a spraying zone. A brush assembly is disposed within the brushing zone of the housing and includes a plurality of rotary brushes. A conveyer assembly is disposed within the spraying zone and includes a conveyer belt having through openings formed therein for allowing liquid to pass through the conveyer belt.

According to another embodiment of the disclosure, a produce washer comprises a housing defining an interior for passing produce therethrough, a dispensing system including a plurality of dispensing nozzles disposed in the interior of the housing and configured to dispense a liquid at the produce, and a recirculation system for returning the liquid sprayed by the dispensing nozzles back to the dispensing system.

### BRIEF DESCRIPTION OF THE DRAWINGS

The above, as well as other advantages of the present disclosure, will become readily apparent to those skilled in the art from the following detailed description, particularly when considered in the light of the drawings described hereafter.

FIG. 1 is a perspective view of a produce washer according to an embodiment of the present invention;

FIG. 2 is a cross-sectional side elevational view of the produce washer;

FIG. 3 is an enlarged side elevational view of a brush assembly having an offset between adjacent rotary brushes of the brush assembly;

FIG. 4 is an enlarged fragmentary side elevational view of a sprocket and chain connection formed between adjacent rotary shafts of the brush assembly;

FIG. 5 is a fragmentary top plan view showing a portion of a conveyer belt of the produce washer;

FIG. 6 is a perspective view showing a dispensing system of the produce washer in isolation; and

FIG. 7 is a cross-sectional side elevational view of a funnel structure, a hydrosieve, and a reservoir tank forming a filtration system of the produce washer.

### DETAILED DESCRIPTION OF THE INVENTION

The following detailed description and appended drawings describe and illustrate various exemplary embodiments of the invention. The description and drawings serve to enable one skilled in the art to make and use the invention, and are not intended to limit the present disclosure, application, or uses.

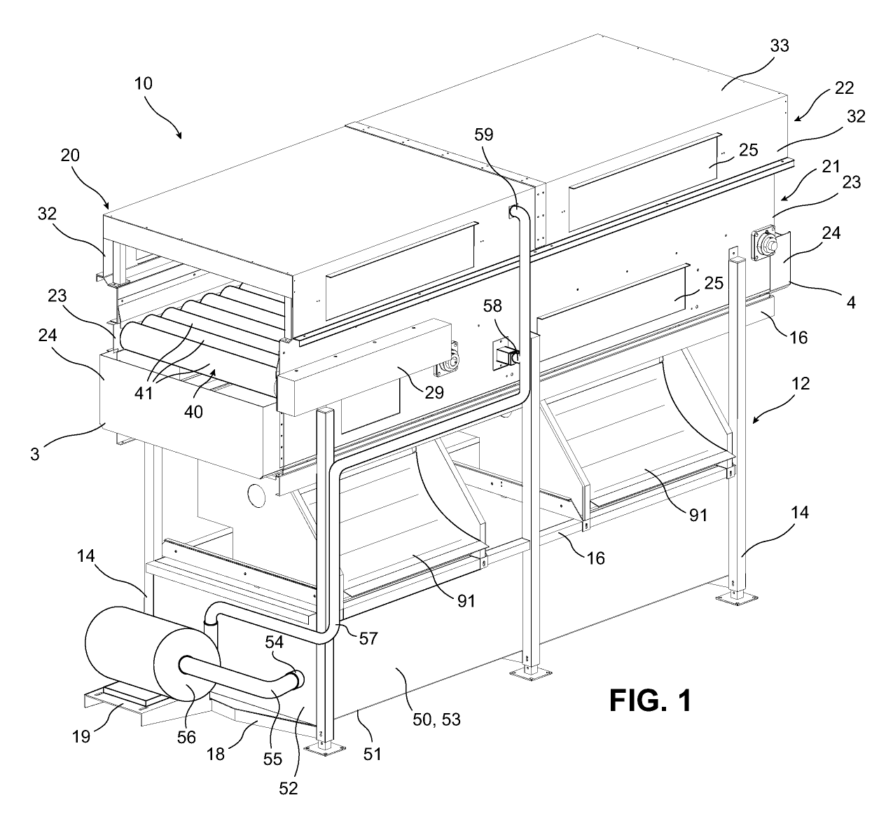

FIGS. 1-7 illustrate a produce washer 10 according to an embodiment of the present invention. The produce washer 10 is configured for washing and rinsing produce such as fruits and vegetables, but it is understood that any variety of goods may be washed and rinsed during use of the produce washer 10 as shown and described herein. The produce washer 10 generally includes a reservoir tank 50, a filtration system 90 in the form of one or more hydrosieves 91 disposed above the reservoir tank 50, and a washer housing 20 disposed above the filtration system 90 containing components for washing and transporting the produce during operation of the produce washer 10. The produce follows a produce pathway within the washer housing 20 formed by a brush assembly 40 and a conveyer assembly 60. The produce washer 10 includes a recirculation system for continuously circulating a liquid through the different components forming the produce washer 10. The recirculation system further includes a dispensing system 80 for dispensing the liquid towards the produce while the produce is traversing the produce pathway, thereby washing and/or rinsing the produce.

The liquid is described generally hereinafter as water, which includes both tap water and distilled water. However, the produce washer 10 may be used with any suitable cleaning substance having similar flow characteristics to water without necessarily departing from the scope of the present invention. For example, the liquid circulated through the produce washer 10 may be water mixed with a surfactant or similar cleaning agent, as desired, without negatively affecting operation of the produce washer 10.

As used herein, references to terms such as “upper,” “lower,” “above,” “below,” and the like refer to relationships with respect to a vertical direction of the produce washer 10 arranged parallel to the direction of the force of gravity. The vertical direction may also be referred to as the height dimension of various components forming the produce washer 10. The produce washer 10 is also described as extending longitudinally from a first end to a second end thereof, wherein the longitudinal direction is horizontal and extends in the general direction of travel of the produce when traversing the pathway of the washer housing 20 during the washing process. The longitudinal direction may alternatively be referred to as the length dimension of the produce washer 10. The produce washer 10 also extends laterally or transversely in a horizontal direction arranged perpendicular to the longitudinal direction. The lateral or transverse direction may alternatively be referred to as the width dimension of the produce washer 10.

The produce washer 10 is shown in FIGS. 1-7 as including a structural frame 12 for supporting and mechanically coupling the reservoir tank 50, the filtration system 90, and the washer housing 20 to each other. However, one skilled in the art should appreciate that the disclosed components may be otherwise mechanically coupled to each other while maintaining the same general relationships without departing from the scope of the present invention. For example, the disclosed components may be wall mounted or mounted to a mobile or wheeled structure while maintaining the ability to operate in the manner disclosed herein so long as the relevant components are positioned relative to each other in the manner disclosed.

In the present example, the structural frame 12 includes three vertically extending posts 14 on each lateral side of the produce washer 10 with each of the posts 14 spaced from each other in the longitudinal direction of the produce washer 10, thereby resulting in a total of six of the posts 14 spaced around a perimeter of the produce washer 10. A middle pair of the posts 14 may be disposed at a longitudinal center of the produce washer 10 between a first one and a second one of the hydrosieves 91 forming the filtration system 90, as desired. The structural frame 12 further includes a plurality of longitudinal members 16, wherein each of the longitudinal members 16 couples two or more of the posts 14 to each other along one lateral side of the produce washer 10. Each opposing pair of the posts 14 in alignment with respect to the longitudinal direction of the produce washer 10 may further includes a laterally extending cross-member 18 extending therebetween at the base of each of the posts 14, wherein the cross-members 18 cooperate to support a bottom surface of the reservoir tank 50. The cross-member 18 formed at the first end of the produce washer 10 may further include a support platform 19 extending therefrom for supporting a pump 56 of the produce washer 10.

Each lateral side of the produce washer 10 may include one of the longitudinal members 16 coupled to an upper end of each of the posts 14 formed on that lateral side of the produce washer 10. The upper ends of each of the posts 14 may be further coupled to a portion of the washer housing 20 to rigidly couple the washer housing 20 to the remainder of the structural frame 12. Although not shown, the structural frame 12 may further include additional cross-members 18 extending between any of the opposing and laterally spaced longitudinal members 16 for further adding support to the different portions of the produce washer 10 such as the washer housing 20, as desired.

The structural frame 12 may be formed from any one or any combination of rigid materials suitable for accommodating the forces experienced by the produce washer 10, including the weight of each of the components forming the produce washer 10, the produce washed by the produce washer 10, and the water circulating through the produce washer 10, as well as any forces exerted on the produce washer 10 during an operation thereof. The material or materials selected for forming the structural frame 12 may also be chosen based on the chemical reactivity of the selected materials when encountering any liquid circulated by the produce washer 10 or any specific type of produce passed through the produce washer 10. The material may also be selected to be able to endure any internal pressures applied by the liquid when transported through various components of the produce washer 10. The structural frame 12 may be formed from a metallic material, such as stainless steel, as one non-limiting example. However other metals, rigid polymeric materials, or composite materials may be used without departing from the scope of the present invention.

The structural frame 12 may also be coupled to the corresponding components using any known coupling method suitable for the chosen materials forming the structural frame 12. For example, metallic materials may be joined to each other using a suitable metal joining process such as welding. Alternatively, the structural frame 12 and the associated components may include any necessary structure for receiving threaded fasteners such as bolts or the like for securely coupling the components to each other. One skilled in the art should appreciate that any suitable coupling methods may be used for forming the general structure of the structural frame 12 and the washer housing 20 without departing from the scope of the present invention, as desired.

The washer housing 20 forms a longitudinally extending and open ended structure for delimiting a flow of the liquid used during the washing process carried out within the washer housing 20. The washer housing 20 may be formed from the same materials described as suitable for forming the structural frame 12. The washer housing 20 is shown as including a lower portion 21 directly coupled to the structural frame 12 as well as an upper portion 22 disposed above and directly coupled to the lower portion 21 of the washer housing 20.

The lower portion 21 of the washer housing 20 includes a pair of oppositely arranged lower side walls 23 extending longitudinally along each lateral side of the produce washer 10 and a pair of end caps 24 joining the lower side walls 23 at each end 3, 4 of the produce washer 10. Each of the lower side walls 23 includes one or more access openings that are selectively covered by a corresponding removable access panel 25. The disclosed access panels 25 are configured to be slidingly received in corresponding structure of each of the lower side walls 23 to allow for selective access to the portions of the interior of the washer housing 20 adjacent each of the access openings.

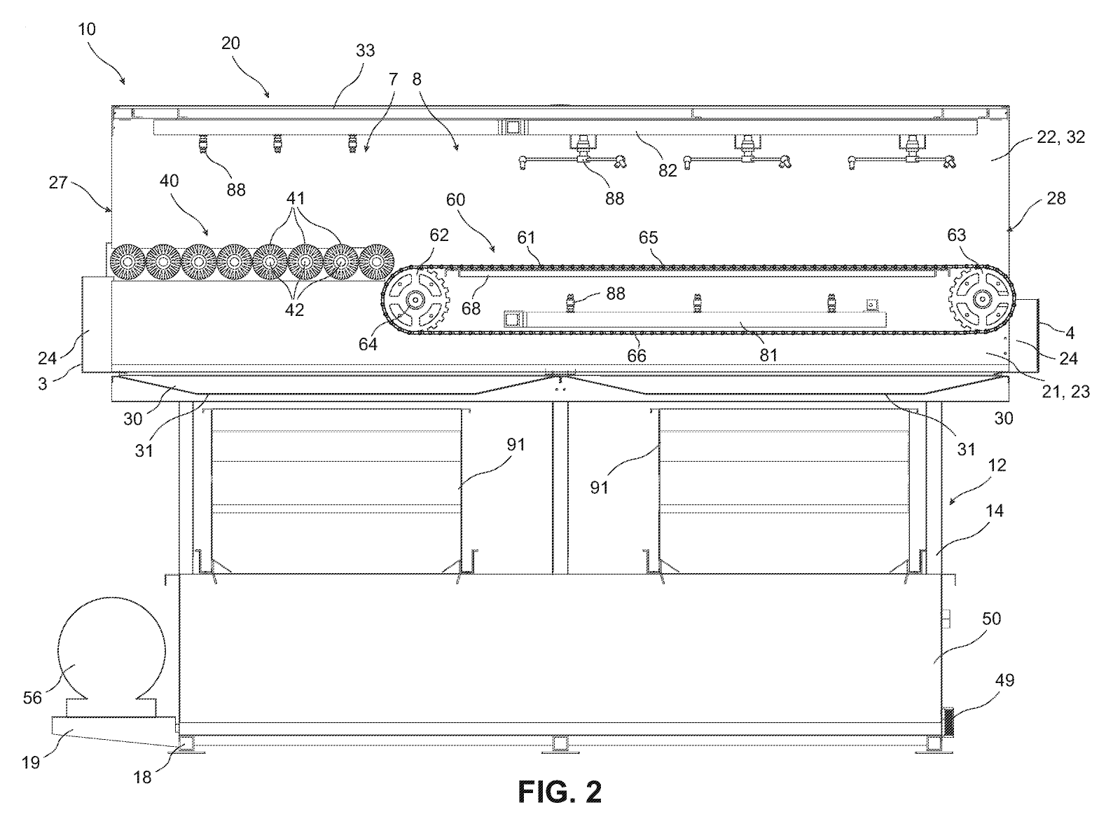

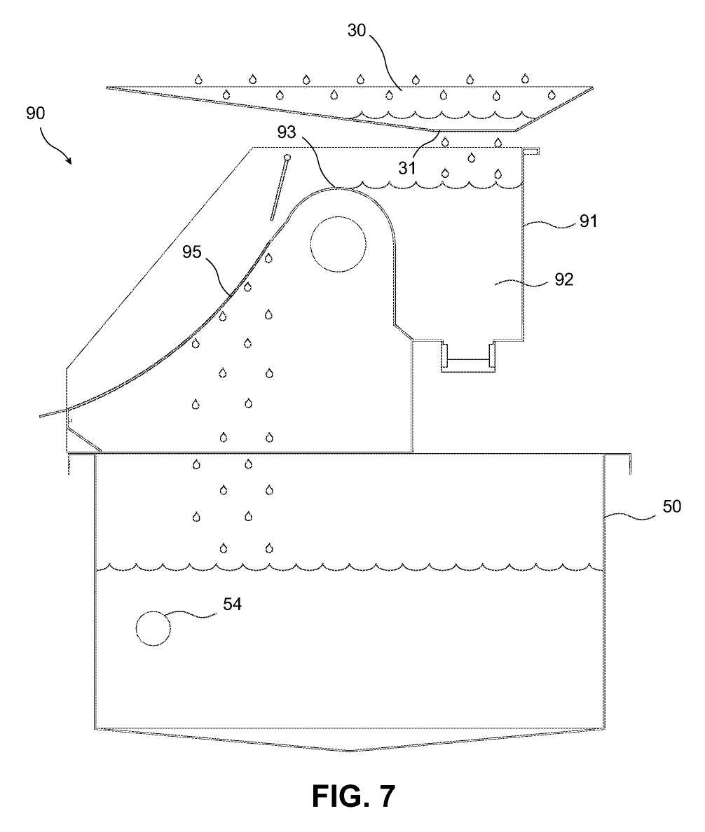

As best shown in FIG. 2, the lower portion 21 of the washer housing 20 further includes one or more funnel structures 30 for directing liquid originating from the washer housing 20 towards the filtration system 90 of the produce washer 10. In the present embodiment, the filtration system 90 includes a pair of longitudinally spaced hydrosieves 91 supported on the reservoir tank 50 and a pair of the funnel structures 30, with each of the funnel structures 30 corresponding to one of the hydrosieves 91. Each of the funnel structures 30 may be formed by four tapered walls forming a substantially pyramidal shape for directing flow into one of the hydrosieves 91. As shown in FIG. 7, each of the funnel structures 30 may be asymmetrical with respect to a central longitudinal axis of the produce washer 10 to bias the flow of the water towards one lateral side of the produce washer 10 for properly directing the flow towards a corresponding portion of one of the hydrosieves 91. The funnel structures 30 form a bottommost portion of the washer housing 20 and may be coupled to the lower side walls 23, the end caps 24, or any other suitable portion of the structural frame 12. The funnel structures 30 extend across an entirety of the underside of the washer housing 20 with the exception of flow openings 31 formed therethrough in order to prevent leakage of the liquid towards portions of the produce washer 10 other than the reservoir tank 50. The end caps 24 are further provided as delimiting surfaces for preventing the flow of the water from either of the longitudinal ends of the washer housing 20 while redirecting such flow back towards one of the downwardly tapered walls of one of the corresponding funnel structures 30.

The upper portion 22 of the washer housing 20 is substantially U-shaped in configuration with the end portions of the U-shape coupled to the uppermost surfaces of each of the lower side walls 23 of the lower portion 21 of the washer housing 20. The upper portion 22 of the washer housing 20 includes a pair of upper side walls 32 and a top wall 33 extending laterally between and connecting the upper side walls 32 to form the U-shaped configuration. The upper side walls 32 of the upper portion 22 further include one or more access openings that are selectively covered by corresponding access panels 25 in the same manner as described with reference to the lower portion 21 of the washer housing 20.

Although the washer housing 20 is shown and described as having separate lower and upper portions 21, 22, one skilled in the art should appreciate that any combination of housing elements cooperating to form the general configuration of the washer housing 20 may be utilized, including the use of a single U-shaped housing structure coupled to the funnel structures 30 for forming the combined configuration of the disclosed lower and upper portions 21, 22. In any event, the washer housing 20 generally includes a top wall forming a ceiling of the hollow interior of the washer housing 20, a pair of sidewalls forming lateral side surfaces of the hollow interior, and one or more funnel structures 30 forming a floor of the washer housing 20 regardless of the number of housing components utilized in forming the washer housing 20.

The washer housing 20 includes an entrance opening 27 formed between one of the end caps 24 and the upper wall 33 at the first end 3 of the produce washer 10 as well as an exit opening 28 formed between the other of the end caps and the upper wall at the second end 4 of the produce washer 10. The produce washed by the produce washer 10 enters the washer housing 20 through the entrance opening 27, traverses the produce pathway within the washer housing 20, and then exits the washer housing 20 through the exit opening 28.

As shown in FIG. 2, the interior of the washer housing 20 may be divided longitudinally into a plurality of different zones with each of the zones associated with a different process occurring with respect to the produce when traversing the produce pathway. In the provided example, the washer housing 20 is divided into a brushing zone 7 including the brush assembly 40 and a spraying zone 8 including the conveyer assembly 60. The brushing zone 7 begins at the entrance opening 27 of the washer housing 20 and extends away from the first end 3 of the produce washer 10 towards the second end 4 thereof before reaching the spraying zone 8. The spraying zone 8 extends away from the brushing zone 7 towards the second end 4 of the produce washer 10 and terminates at the exit opening 28 of the washer housing 20.

The brush assembly 40 includes a plurality of rotary brushes 41 configured to apply a gentle brushing action to the produce when traversing the brushing zone 7 of the produce pathway. The rotary brushes 41 cooperate to form a portion of the produce pathway on which the produce travels when passing through the produce washer 10. Each of the rotary brushes 41 has an axis of rotation defined by a rotary shaft 42 arranged to extend in the lateral direction of the produce washer 10 between the opposing side walls of the washer housing 20. Each end of each of the rotary shafts 42 may be rotatably supported by a bearing assembly (not shown) coupled to one of the side walls to facilitate rotation of each of the rotary brushes 41 about the corresponding axis of rotation thereof. As shown in FIG. 1, the washer housing 20 may include an enclosure 29 for housing the bearing assemblies at each lateral side of the produce washer 10. Each of the enclosures 29 may be removable to selectively access the brush assembly 40 when performing maintenance thereon.

The entirety of the brush assembly 40 may be driven by a single actuator (not shown) operatively coupled to the rotary shaft 42 of one of the rotary brushes 41. The single actuator may be an electric motor, such as a variable frequency drive motor adjustable to a plurality of different torques and/or rotational speeds. It should be appreciated by one skilled in the art that any form of rotary drive mechanism may be employed without departing from the scope of the present invention.

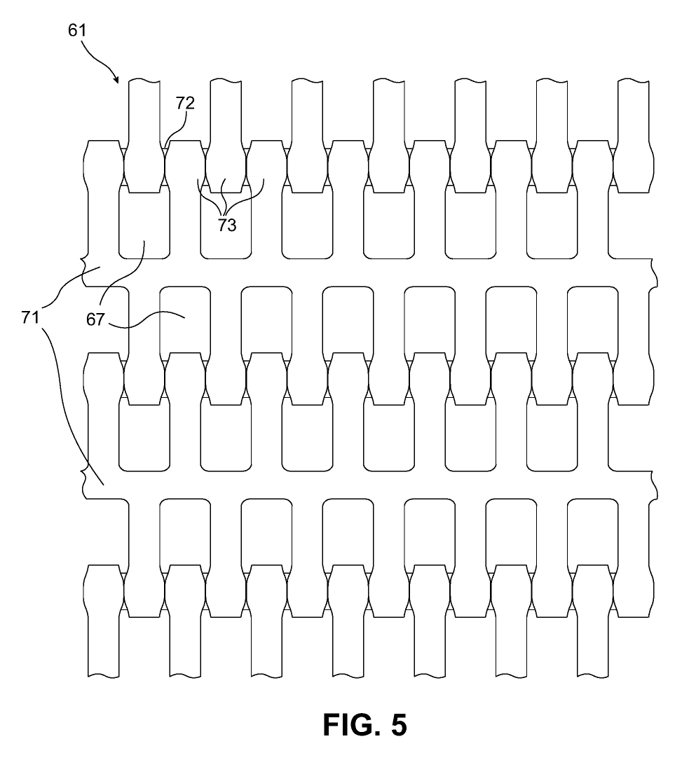

The rotational motion of the single actuator may be transferred to the rotary shaft 42 of each of the rotary brushes 41 via use of a chain and sprocket connection between adjacent rotary shafts 42 at one lateral side of the produce washer 10. For example, as shown in FIG. 4, a chain 45 may extend in a loop between the rotary shafts 42 of each adjacent pair of the rotary brushes 41. Each of the chains 45 engages a sprocket wheel 46 associated with and rigidly coupled to one of the rotary shafts 42. The outermost rotary brushes 41 include only one of the sprocket wheels 46 while the intermediate rotary brushes 41 include two of the sprocket wheels 46 with the sprocket wheels 46 spaced in the direction of extension of the axis of rotation of each corresponding rotary brush 41 (the rearward of each of the sprocket wheels is obstructed by each of the rearward chains in the illustrated embodiment). The single sprocket wheel 46 of the driven one of the rotary shafts 42 transfers the rotational motion thereof to one of the sprocket wheels 46 of the adjacent one of the intermediate rotary shafts 42 via an interconnecting one of the chains 45. The other axially displaced sprocket wheel 46 of the intermediate rotary shaft 42 thereby transfers the rotational motion to the next of the rotary shafts 42 via the next interconnecting chain 45, and so forth and so on until each of the rotary brushes 41 is caused to rotate in unison.

The use of the successive sprocket wheel and chain connections leads to each of the rotary brushes 41 rotating in a common rotational direction, which is clockwise from the perspective of FIG. 2 in order to promote the forward motion of the produce along the produce pathway. In the provided embodiment, each of the sprocket wheels 46 associated with each of the rotary shafts 42 has a common diameter in order to rotate each of the rotary brushes 41 at the same rotational speed based on the rotational speed of the driven rotary brush 41. However, in other embodiments, each of the sprocket wheels 46 associated with one of the rotary shafts 42 may include a different diameter from the sprocket wheels 46 of an adjacent one of the rotary shafts 42 in order to increase or slow the rotational speed of the differing one of the rotary shafts 42 relative to the adjacent one of the rotary shafts 42. In this respect, the brush assembly 40 can be further configured to alter the brushing action and the rolling or agitating applied to the produce when traversing the brushing zone 7 of the washer housing 20.

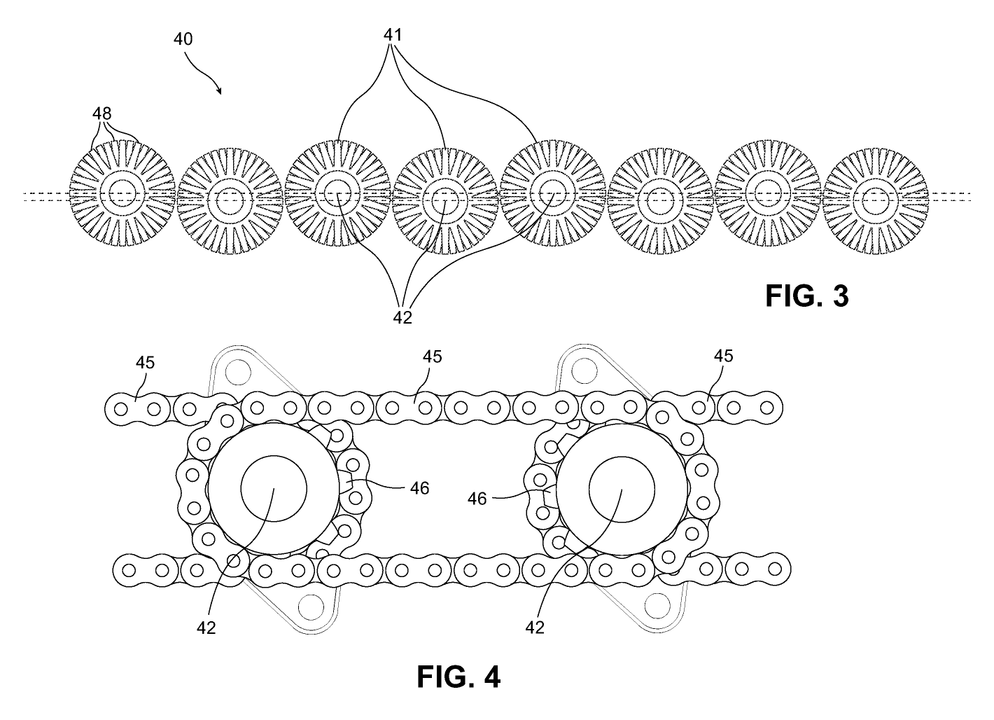

As shown in FIG. 1, each of the rotary brushes 41 is substantially cylindrical in shape as the rotary brushes 41 extend between the opposing side walls of the washer housing 20. As best shown in FIG. 3, each of the rotary brushes 41 includes a plurality of radially outwardly extending fingers 48. The fingers 48 form projections that may be cuboid, cylindrical, or pyramidal in shape. The fingers 48 may be arranged in a plurality of rows spaced apart from each other in the direction of extension of the axis of rotation of each of the rotary brushes 41 (the lateral direction of the produce washer 10), wherein each of the rows includes a plurality of the fingers 48 circumferentially spaced around each of the rotary brushes 41. Each row of the fingers 48 may be angularly offset from an adjacent row of the fingers 48 to cause the fingers 48 of each row to extend between two of the fingers 48 of the adjacent row when viewing the rotary brush 41 from the perspective of the axis of rotation thereof. This alternating offset between each successive row of the fingers 48 causes the distal ends of the fingers 48 to define a cylindrically shaped grid-like pattern with spaces formed between the distal ends of adjacent ones of the fingers 48. This pattern of open spaces and projecting fingers 48 provides an irregular surface for agitating and brushing the produce when passing over the fingers 48. The irregular surface also tends to aid in slowly turning the produce as a result of the constant rolling of the produce over the distal ends of the fingers 48 when progressing along the brush assembly 40. The existence of the spaces also allows for the fingers 48 to easily pivot and flex when encountering the produce in order to apply a resilient brushing action to the exterior of the produce.

The fingers 48 of the rotary brushes 41 are formed from a hygienic material resistant to the absorption of liquids such as water. The liquid impermeability of the fingers 48 is provided in order to inhibit fungal or bacterial growth within the fingers 48. Suitable hygienic materials for forming the fingers 48 of the rotary brushes 41 include, but are not limited to, polymeric materials such as nylon, polyether ether ketone, polyester, polypropylene, polyethylene, polyoxymethylene, polyacetal, and combinations thereof. As used herein, a polymeric material is a material comprising one or more polymers and may be a blend of polymers or a composite comprising one or more polymers and one or more inorganic substances, as desired. It is understood that embodiments of the produce washer 10 wherein the rotary brushes 41 are made from a non-hygienic material are not optimal for produce washing purposes, but are nonetheless encompassed within the present disclosure. The selected material should further include sufficient flexibility and resiliency to continuously flex and recover when encountering the produce during a brushing process. The material forming the fingers 48 should also be selected to include a relatively non-abrasive outer surface in order to prevent damage to the outer surface of the produce during the brushing process.

The axis of rotation of each of the rotary brushes 41 may be disposed on a common plane such as a horizontally extending plane as shown in FIG. 2. Alternatively, the common plane may be inclined at an angle with respect to the horizontally extending plane to cause the rotary brushes 41 to be disposed at progressively increasing or decreasing heights. For example, the rotary brushes 41 may be arranged to include a downward slope with respect to the direction of motion of the produce when traversing the produce pathway in order to facilitate rolling of the produce when passing over each of the rotary brushes 41.

FIG. 3 illustrates an embodiment of the brush assembly 40 wherein a first group of the rotary brushes 41 includes axes of rotation disposed on a first plane and a second group of the rotary brushes 41 includes axes of rotation disposed on a second plane offset from and parallel to the first plane, as indicated by the spaced apart and parallel broken lines shown in FIG. 3. Specifically, the illustrated arrangement includes an alternating offset in the height direction between each of the adjacent rotary brushes 41 with each of the disclosed planes extending horizontally. However, additional offset patterns may be used, including the use of additional planes of offset, multiple brushes 41 disposed successively on a single plane before offsetting to an adjacent plane, parallel arranged planes inclined at an angle relative to the horizontal plane, and combinations thereof. The offset may be relatively small relative to a maximum outer diameter of each of the rotary brushes 41. In some embodiments, the offset between adjacent rotary brushes 41 may be ½ an inch or less, ¼ of an inch or less, ⅛ of an inch or less, or 1/16 of an inch or less. However, any set of offset intervals may be used without departing from the scope of the present invention. The offset in height between adjacent ones or groups of the rotary brushes 41 tends to cause the produce passing over the brush assembly 40 to be continuously rotated, rolled, and otherwise agitated in order to expose additional surfaces of the produce to the brushing action of the rotary brushes 41.

The conveyer assembly 60 includes a conveyer belt 61 looping around a first roller 62 disposed adjacent the brush assembly 40 and a second roller 63 disposed adjacent the exit opening 28 of the washer housing 20. Each of the rollers 62, 63 is supported by a shaft 64 defining an axis of rotation thereof and extending between the lateral side walls of the washer housing 20. The shaft 64 of each of the rollers 62, 63 may be supported by a corresponding bearing assembly coupled to one of the side walls of the washer housing 20, as desired. The conveyer belt 61 includes an upper portion 65 extending between uppermost surfaces of the first and second rollers 62, 63 and a lower portion 66 extending between lowermost surfaces of the first and second rollers 62, 63. As should be understood, the upper portion 65 and the lower portion 66 of the conveyer belt 61 are constantly formed by different segments of the conveyer belt 61 during motion of the conveyer belt 61 relative to the first and second rollers 62, 63. The conveyor belt 61 may be driven by any type of rotary drive mechanism (not shown) operatively coupled to one of the shafts 64 of one of the rollers 62, 63. The rotary drive mechanism may be an electric motor such as a variable frequency drive motor, as desired.

The upper portion 65 of the conveyer belt 61 forms a portion of the produce pathway on which the produce travels when passing through the produce washer 10. As shown in FIG. 2, there may be an offset in height between an end of the brush assembly 40 and an end of the upper portion 65 of the conveyer belt 61 to facilitate rolling or the like to the produce when transitioning from the brushing zone 7 to the spraying zone 8. The upper portion 65 of the conveyer belt 61 is shown as being disposed on a horizontally extending plane, but it should be understood that the first and second rollers 62, 63 may be arranged with a height difference to form a slight incline in the upper portion 65 of the conveyer belt 61 for aiding the rolling or the like of the produce. The upper portion 65 of the conveyer belt 61 may be at least partially supported by a conveyer support 68 structure extending between the opposing side walls of the washer housing 20 and disposed within the loop formed by the conveyer belt 61. The conveyer support structure 68 may be formed by a plurality of longitudinal members and a plurality of laterally extending cross-members spaced from each other to form large gaps in the conveyer support structure 68 for allowing water to flow therethrough. The conveyer support structure 68 is configured to aid in supporting the weight of the produce when traversing the spraying zone 8 along the upper portion 65 of the conveyer belt 61.

The conveyor belt 61 is made of a hygienic material. Suitable hygienic materials include, but are not limited to, polypropylene, polyethylene, polyoxymethylene, polyacetal, or combinations thereof. It is understood that embodiments of the produce washer 10 where the conveyor belt 61 is made from a non-hygienic material are not optimal for produce washing purposes, but are nonetheless encompassed within the present disclosure.

The conveyor belt 61 includes a plurality of openings 67 formed from one major surface to the other major surface thereof to allow for water to flow through the conveyer belt 61 without substantial resistance. The openings 67 can be arranged in any suitable pattern and quantity. FIG. 5 shows one non-limiting exemplary arrangement of the openings 67 in the conveyor belt 61. The conveyer belt 61 is shown as being composed of a plurality of segments 71 extending in the lateral direction of the produce washer 10 connected to each other by laterally extending connecting rods 72. The connecting rods 72 extend through interlocking knuckles 73 extending alternatingly from each of the coupled segments 71. In the shown embodiment, the conveyor belt 61 provides about 36% openness for water (or other liquid) passage through the conveyer belt 61, and about 20% contact area. However, it is understood that other configurations of the conveyor belt segments 71 are possible and encompassed within the present disclosure. One non-limiting example of a suitable conveyor belt 61 is the Series 6.1-36 FLT belt commercially available from Siegling Prolink. This particular example conveyor belt has openings of various sizes, with the largest opening being about 11.7×15.2 mm (0.46×0.60 in).

In other embodiments, the openings 67 may take the form of small pores, or may be large openings spanning a significant amount of the surface area of the conveyer belt 61. For example, the openings 67 may be a series of small pores, on the order of a few millimeters in diameter, or may be large openings which cumulatively result in from about 1% to about 50% of the surface area of the conveyer belt 61 being open to the passage of water (or other liquid) therethrough.

Furthermore, it is possible that multiple conveyor belts 61, such as a series of two or more adjacent loops of the conveyer belts 61, may be employed within the washer housing 20. In such a configuration, the different conveyer belts 61 may be employed at offset heights in order to further roll or agitate the produce when transitioning from one conveyer belt 61 to the next.

The produce washer 10 may be customized in size. For example, the washer housing 20 can be made with a width of about 36 inches, about 48 inches, or about 60 inches, as non-limiting examples. The produce washer 10 may also be formed with any desired length to facilitate the desired washing and/or rinsing of the produce when traversing the produce pathway. One skilled in the art will recognize that the ideal size of the produce washer 10 will depend on the intended use of the produce washer 10.

The recirculation system of the produce washer 10 includes the reservoir tank 50, a first conduit 55, the pump 56, a second conduit 57, the dispensing system 80, the funnel structures 30, and finally the filtration system 90 for filtering the water before returning the water back to the reservoir tank 50. The dispensing system 80 includes an upper manifold 81, a lower manifold 82, and a plurality of dispensing nozzles 88 with each of the dispensing nozzles 88 in fluid communication with one of the manifolds 81, 82.

The reservoir tank 50 includes a substantially cuboid shaped hollow opening for receiving and storing the water to be circulated through the produce washer 10. The hollow opening is defined by a base wall 51, a pair of oppositely arranged end walls 52, and a pair of oppositely arranged side walls 53. As shown in FIG. 1, the end wall 52 at the first end 3 of the produce washer 10 may include an opening formed therein acting as a reservoir outlet 54 for removing the water from the reservoir tank 50. A pipe or similar structure (not shown) may extend downwardly from the opening and into the hollow interior of the reservoir tank 50 to facilitate the removal of the water from a lower portion of the reservoir tank 50. As shown in FIG. 2, the reservoir tank 50 may include a drain plug 49 at a lowermost portion of one of the end walls 52 for selectively draining the water from the reservoir tank 50 following use of the produce washer 10.

The first conduit 55 fluidly couples the reservoir outlet 54 of the reservoir tank 50 to an inlet or low pressure end of the pump 56. The pump 56 may be any liquid pump suitable for continuously pumping the liquid out of the reservoir tank 50 and towards the washer housing 20 against the force of gravity during the washing process. The pump 56 is configured to increase the pressure of the water in order to deliver the water to a desired pressure when traversing the second conduit 57 and when dispensed by the dispensing system 80.

The second conduit 57 extends from an outlet or high pressure end of the pump 56 and towards the dispensing system 80 within the washer housing 20. The second conduit 57 is shown as extending along the structural frame 12 of the washer housing 20 until reaching the dispensing system 80. The second conduit 57 includes a first outlet 58 fluidly coupled to the lower manifold 81 and a second outlet 59 fluidly coupled to the upper manifold 82. The second conduit 57 may be formed from a rigid material suitable for secure coupling directly to the structural frame 12 of the produce washer 10.

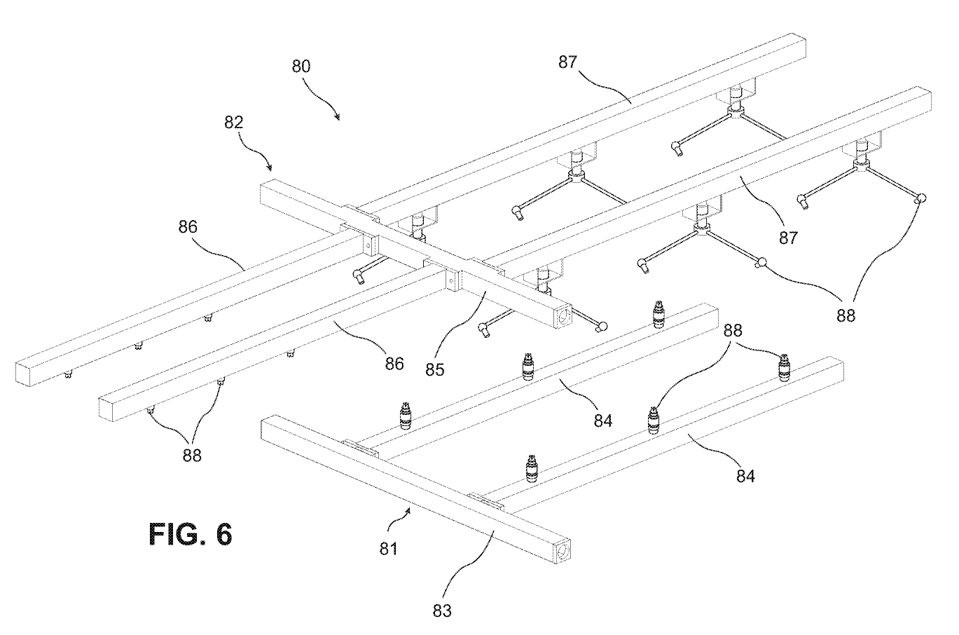

FIG. 6 illustrates the dispensing system 80 of the produce washer 10 in isolation to more easily discern the spatial relationships between the various components thereof in the absence of the washer housing 20. The lower manifold 81 includes a laterally extending hollow member 83 fluidly coupled to a pair of longitudinally extending hollow members 84. As shown in FIG. 2, the lower manifold 81 is disposed within the loop of the conveyer belt 61 intermediate the upper and lower portions 65, 66 thereof and may be supported by any laterally extending cross-members of the washer housing 20 as well as the laterally extending hollow member 83, which extends between the opposing side walls of the washer housing 20.

Each of the pair of the longitudinally extending hollow members 84 includes three of the dispensing nozzles 88 mechanically and fluidly coupled thereto with each of the dispensing nozzles 88 pointed upwardly towards the upper portion 65 of the conveyer belt 61. The dispensing nozzles 88 are spaced longitudinally at desired locations for spraying the water through gaps formed within the conveyer support structure 68. The dispensing nozzles 88 may be provided as straight nozzles configured to spray the water in a single continuous direction. The dispensing nozzles 88 may be selected to have a desired spread angle when ejecting the water therefrom in a conical spray. The dispensing nozzles 88 may be directed vertically upward or may be angled with respect to the vertical direction, as desired.

The upper manifold 82 may be coupled to the top wall 33 of the washer housing 20 to position the upper manifold 82 above each of the brush assembly 40 and the conveyer assembly 60. The upper manifold 82 includes a laterally extending hollow member 85 fluidly coupled to each of a first pair of longitudinally extending hollow members 86 extending into the brushing zone 7 above the brush assembly 40 and a second pair of longitudinally extending hollow members 87 extending into the spraying zone 8 above the conveyer assembly 60. Each of the longitudinally extending hollow members 86, 87 is mechanically and fluidly coupled to three of the dispensing nozzles 88. The six dispensing nozzles 88 directed towards the brush assembly 40 are disposed above the brush assembly 40 and direct the water towards an upper surface of the brush assembly 40. The dispensing nozzles 88 directed towards the brush assembly 40 may be straight nozzles having the same configuration as the straight nozzles of the lower manifold 81. In contrast, the dispensing nozzles 88 disposed above and directed towards the upper portion 65 of the conveyer belt 61 are provided as spinner nozzles, which are nozzles which spin or rotate while spraying as a result of the expulsion of the water therefrom. The spinner nozzles may be capable of 360° spraying while still directing the water generally downwards towards the produce disposed on the upper portion 65 of the conveyer belt 61. Although not shown herein, in other embodiments, the dispensing nozzles 88 may be directional nozzles, wherein the directional nozzles are capable of swiveling or pivoting while spraying.

The use of the upper manifold 81 and the lower manifold 82 has been found to increase the pressure of the water when dispensed by the dispensing system 80 in comparison to the use of multiple independent flow hoses corresponding to each of the dispensing nozzles 88. The manifolds 81, 82 are also suitable for being formed from substantially rigid materials that further aid in adding structural support to the washer housing 20 while also being easily coupled to the remainder of the produce washer 10.

As mentioned previously, the filtration system 90 is formed by a pair of hydrosieves 91 with each of the hydrosieves 91 corresponding to one of the funnel structures 30 of the washer housing 20. Each of the hydrosieves 91 may include a base structure 96 suitable for resting on a corresponding ledge formed by a perimeter rim of the reservoir tank 50.

FIG. 7 illustrates a sectional view of one of the funnel structures 30, one of the hydrosieves 91, and the reservoir tank 50 to illustrate the flow path for the water passing through the filtration system 90. As shown by the illustrated water droplets, the water sprayed within the washer housing 20 is collected within the funnel structure 30 and directed towards a first separation chamber 92 of the hydrosieve 91. The first separation chamber 92 includes a depth in the height direction of the produce washer 10 and is configured to separate especially heavy particles of debris from the circulating water. An arcuate overflow crest 93 of the hydrosieve 91 is configured to direct water from the first separation chamber 92 to a sieve element 95 disposed to other side of the overflow crest 93 when the first separation chamber 92 overflows, which occurs constantly during the operation of the produce washer 10. The sieve element 95 is a screen including an array of relatively small openings suitable for filtering relatively small particles of debris such as sand from the water. The sieve element 95 is substantially arcuate in shape and is concave when viewed from an external perspective. The water passing through the sieve element 95 falls into the fluid reservoir 50 where the process can repeat again when the newly filtered water is again drawn through the reservoir outlet 54 and towards the pump 56.

The produce washer 10 may include a control system in signal communication with each of the disclosed drive mechanisms as well as the pump 56 in order to operate the brush assembly 40, the conveyer assembly 60, and the dispensing system 80 at desired speeds and flow rates. Alternatively, an operator of the produce washer 10 may control each of the disclosed components independently to operate the produce washer 10 at the desired settings.

In use, the operator of the produce washer 10 initiates the pump 56 and the drive mechanisms associated with the brush assembly 40 and the conveyer assembly 60 to start circulation of the water as well as motion of the rotary brushes 41 and the conveyer belt 61. The produce is introduced to the produce pathway by placing the produce on the brush assembly 40 via entry through the entrance opening 27 formed at the first end 3 of the produce washer 10. The produce begins down the produce pathway by progressing through the brushing zone 7 while being brushed by the fingers 48 of the rotary brushes 41. While brushed by the rotary brushes 41, the produce tends to vibrate, shake, roll, and otherwise move in order to expose additional surfaces of the produce to the brushing action. The undulating profile of the brush assembly 40 further aids in rolling or turning the produce when transitioning from one rotary brush 41 to the next 41. As disclosed in FIG. 3, the rotary brushes 41 may be offset from each other to further introduce additional agitation to the produce.

The produce is simultaneously sprayed with the water originating from one of the dispensing nozzles 88 disposed above the brush assembly 40 while the produce passes through the brushing zone 7. The pressure of the water may be sufficient for directly removing dirt and debris from the produce or the water may merely rinse the dirt and debris loosened by the brushing action of the brush assembly 40.

The produce eventually passes over each of the rotary brushes 41 before entering the spraying zone 8 via a dropping of the produce from the last of the rotary brushes 41 and onto the upper portion 65 of the conveyer belt 61. The motion of the conveyer belt 61 causes the produce to continue to proceed towards the second end 4 of the produce washer 10 while traversing the produce pathway. The produce is subjected to water spray from dispensing nozzles 88 disposed both above and below the upper portion 65 of the conveyer belt 61 in a manner wherein opposing sides of the produce are sprayed simultaneously. The dispensing nozzles 88 disposed directly above the conveyer belt 61 direct the spray downwards towards the upper portion 65 of conveyer belt 61 while the dispensing nozzles 88 disposed below the upper portion 65 of the conveyer belt 61 direct the spray at the underside of the upper portion 65. The inclusion of the openings 67 within the conveyer belt 61 allows for the water originating from the above the conveyer belt 61 to easily flow through the conveyer belt 61 and towards a corresponding funnel structure 30. The openings 67 further allow for the spray originating from below the upper portion 65 of the conveyer belt 61 to pass directly through the openings 67 in order to strike the underside of the produce with sufficient pressure.

The spraying zone 8 may be utilized primarily for rinsing the produce after traversing the brushing zone 7 or the spraying zone 8 may be utilized to further remove dirt and debris from the produce during an extending washing process including both the brushing zone 7 and the spraying zone 8. It should be understood by one skilled in the art that the effects of the water within the spraying zone 8 may be dependent on the pressure of the water sprayed at the produce within the spraying zone 8.

The produce eventually reaches the end of the conveyer belt 61 where the produce is able to exit the washer housing 20 through the exit opening 28 thereof. Although not shown, the produce washer 10 may be used in conjunction with a suitable conveyer system or the like receiving the produce after being washed by the produce washer 10. The produce washer 10 may optionally include a drying mechanism (not shown) or the like at the exit opening 28 for delivering heated air at the washed produce.

During the washing of the produce, the water originating from the dispensing system 80 in continuously passing between adjacent ones of the rotary brushes 41 or through the openings 67 formed through the conveyer belt 61 in a manner wherein the sprayed water is constantly being directed downwardly by a corresponding one of the funnel structures 30 coupled to the underside of the washer housing 20. The funnel structures 30 direct the flow into a corresponding one of the hydrosieves 91 where the dirt and debris removed from the produce is filtered by the first separation chamber 92 and the sieve element 95. The filtered water is then reintroduced back into the reservoir tank 50 where the water can again be pumped by the pump 56 and delivered towards the lower manifold 81 and the upper manifold 82 of the dispensing system 80 to repeat the cycle.

The disclosed produce washer 10 offers many advantageous features. The recirculation and continuous filtration of the water through the produce washer 10 results in the ability to continuously operate the produce washer 10 at high flow rates without requiring an independent source of the water or replaceable and costly filter elements. The use of hygienic, anti-microbial, and anti-fungal rotary brushes 41 allows for continued use of the rotary brushes 41 without having to constantly clean or replace the rotary brushes 41 due to contamination thereof. The relatively soft and flexible polymeric material forming the fingers 48 of the rotary brushes 41 also allows for gentle brushing action to occur without damaging the corresponding produce. The use of a conveyer belt 61 having a high degree of water passage therethrough allows for increased draining of the water as well as the ability to approach the produce with sprayed water from both above and below the supporting surface of the conveyer belt 61. The compact arrangement of the dispensing system 80 aids in delivering the water at a desired and substantially equal pressure at each of the dispensing nozzles 88 via the corresponding manifolds 81, 82. Lastly, the produce pathway includes various offsets in the height direction of the produce washer 10 to cause the produce passing along the produce pathway to be further rolled or agitated during the washing process, thereby ensuring that an entirety of the produce is washed and rinsed.

Finally, it should be understood that the basic principles of the present invention may be adapted for use in a produce washer having any number of different zones, including an alternating pattern of the brushing zones and the spraying zones, as desired. It should further be understood that the dispensing nozzles 88 may be provided at different positions and orientations within the washer housing 20 than those shown and described, including directing the spray laterally at the produce from one of the side walls of the washer housing 20.

While certain representative embodiments and details have been shown for purposes of illustrating the invention, it will be apparent to those skilled in the art that various changes may be made without departing from the scope of the disclosure, which is further described in the following appended claims.

What is claimed is:

1. A produce washer comprising:
a housing defining an interior for passing produce therethrough, the interior of the housing divided into a brushing zone and a spraying zone;
a brush assembly disposed within the brushing zone of the housing, the brush assembly including a plurality of rotary brushes; and
a conveyer assembly disposed within the spraying zone, the conveyer assembly including a conveyer belt having through openings formed therein for allowing liquid to pass through the conveyer belt.

2. The produce washer of claim 1, further comprising a dispensing system having a plurality of dispensing nozzles disposed within the interior of the housing, each of the dispensing nozzles configured to spray the liquid towards the produce.

3. The produce washer of claim 2, wherein at least one of the dispensing nozzles is disposed within the brushing zone of the housing.

4. The produce washer of claim 3, wherein the at least one of the dispensing nozzles is disposed above the brush assembly for dispensing the liquid downwardly.

5. The produce washer of claim 2, wherein at least two of the dispensing nozzles are disposed within the spraying zone of the housing.

6. The produce washer of claim 5, wherein the conveyer belt forms a loop including an upper portion for supporting the produce passing through the housing, wherein a first one of the at least two of the dispensing nozzles is disposed above the upper portion of the conveyer belt for dispensing the liquid downwardly and wherein a second one of the at least two of the dispensing nozzles is disposed below the upper portion of the conveyer belt for dispensing the liquid upwardly.

7. The produce washer of claim 6, wherein the first one of the at least two of the dispensing nozzles is a spinning nozzle and wherein the second one of the at least two of the dispensing nozzles is a straight nozzle.

8. The produce washer of claim 1, wherein each of the rotary brushes is substantially cylindrical in shape and includes a plurality of circumferentially spaced and radially outwardly extending fingers.

9. The produce washer of claim 8, wherein the fingers of each of the rotary brushes are arranged in a plurality of spaced apart rows with each of the rows angularly offset from an adjacent one of the rows.

10. The produce washer of claim 1, wherein each of the rotary brushes is formed from a hygienic and substantially liquid impermeable material.

11. The produce washer of claim 10, wherein the material forming each of the rotary brushes is a polymeric material.

12. The produce washer of claim 11, wherein the polymeric material includes at least one of nylon, polyether ether ketone, polyester, polypropylene, polyethylene, polyoxymethylene, and polyacetal.

13. The produce washer of claim 1, wherein the conveyer belt is formed from a plurality of coupled segments, wherein the openings are formed by spaces present between the coupled segments.

14. The produce washer of claim 1, wherein one of the rotary brushes of the brush assembly is offset in a height direction of the produce washer from an adjacent one of the rotary brushes.

15. The produce washer of claim 1, wherein the brush assembly is offset in a height direction of the produce washer from the conveyer assembly.

16. A produce washer comprising:
a housing defining an interior for passing produce therethrough;
a dispensing system including a plurality of dispensing nozzles disposed in the interior of the housing and configured to dispense a liquid at the produce; and
a recirculation system for returning the liquid sprayed by the dispensing nozzles back to the dispensing system.

17. The produce washer of claim 16, wherein the recirculation system includes a reservoir tank for storing a supply of the liquid to be dispensed and a pump for pumping the supply of the liquid to be dispensed to the dispensing system.

18. The produce washer of claim 17, further comprising a filtration system disposed between the housing and the reservoir tank for filtering the liquid dispensed by the dispensing system.

19. The produce washer of claim 18, wherein the filtration system comprises a hydrosieve having a separation chamber, a sieve element, and an overflow crest between the separation chamber and the sieve element.

20. The produce washer of claim 17, wherein the recirculation system includes a conduit fluidly coupling the pump to a manifold for distributing the liquid to the plurality of the dispensing nozzles.
